(19) United States
(12) Patent Application Publication
(10) Pub. No.: US 2002/0163409 A1
(43) Pub. Date: Nov. 7, 2002

(54) Telecommunication relay array for DSL network configuration

(75) Inventors: Bruce Francis Orr, Balgowlah (AU); Patrick Michael Conrick, Bardwell Valley (AU)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/137,333

(22) Filed: May 3, 2002

(30) Foreign Application Priority Data
May 4, 2001 (AU) PR4753

(51) Int. Cl. H01H 51/22

(52) U.S. Cl. 335/78

(57) ABSTRACT

The present invention relates to the structure of a magnetic relay for telecommunication network configuration, said relay having a magnetically cantilevered armature, said contact armature having a section with reduced cross section over a part of its length to provide a hinge action. While the invention is suitable for use in miniaturized relays, it can also be used with larger relays.

This invention relates to the structure of a magnetic relay. While the invention is suitable for use in miniaturized relays, it can also be used with larger relays.

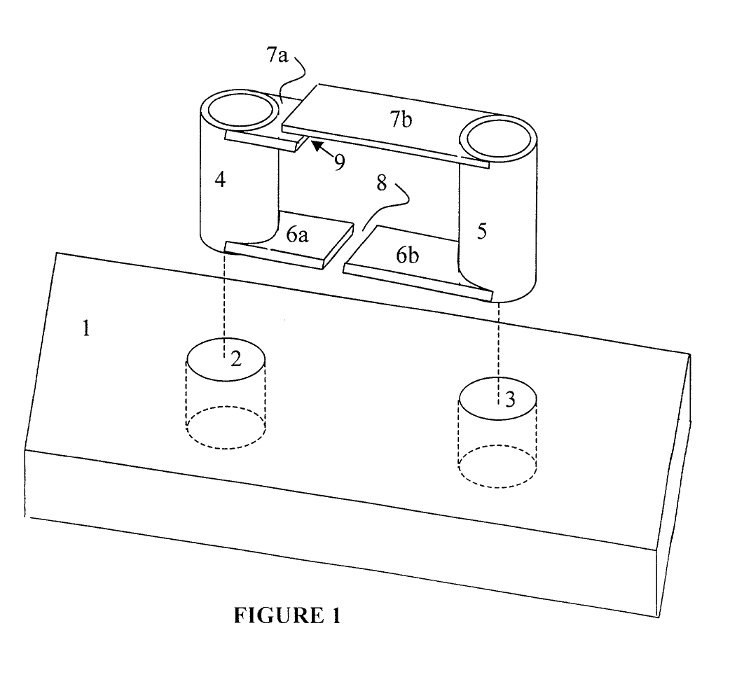

Unpublished patent application EP02290608.5 discloses a miniaturized relay formed integrally in a substrate such as a printed circuit board. In this arrangement, the magnetic circuit is formed by depositing upper and lower sections of the magnetic path on the upper and lower surfaces of the substrate, and then connecting the upper and lower sections by holes through the substrate which are plated or filled with magnetizable (ferro-magnetic) material. The terms upper and lower are used arbitrarily for the purpose of establishing a reference, but the relay may be used in any orientation. The upper path also includes a cantilevered, resilient armature which is spaced above upper surface of the substrate so as to be able to make electrical contact with a contact pad. Preferably the contact pad and the armature are of material which has good ferro-magnetic and electrical conduction characteristics so they form parts of both the magnetic actuation mechanism and the electrical contact path. More precisely, FIG. 1 shows an exploded view of an embodiment of this miniaturized relay having a magnetic path (6a, 6b) and activation coils installed on or in the support member 1. The activation coils are not shown in this figure for the sake of simplifying the view. The support member 1 is preferably a PCB and has vertical magnetic elements 4 and 5 formed in through holes 2 and 3, eg by plating through techniques. The magnetic path consists of a lower transverse member divided into two parts, 6a, 6b, by air or insulating gap 8, and an upper transverse member divided into two parts, 7a, 7b, which are vertically non-aligned and horizontally overlapping to provide a contact gap 9. The part 7a forms a contact pad, and the part 7b forms the flexible relay armature. The vertical gap is provided in this embodiment by extending the vertical pillar 5 to which the armature 7b is attached.

In the design of such a relay there is a trade-off between the thickness of the armature and the force needed to operate the armature. We have found that, in such an arrangement, the armature needs to be made thin to ensure that the magnetic actuation forces are sufficient to operate the armature with a reasonable operating current. Large operating currents can induce saturation in a thin beam. We have found that the armature will operate under when saturated. Nevertheless, large operating currents are required to produce reliable switching of the relay.

An object of the invention is to provide a relay having a magnetically cantilevered armature allowing to have a quite low bending force without having saturation at the operating condition.

More precisely, the invention provides a relay having a magnetically cantilevered contact armature, said contact armature having a section with reduced cross section over a part of its length to provide a hinge action.

In one embodiment, the cantilevered armature is at least in part made of a ferro-magnetic material which has a sufficient cross section to retain a large portion of the operating magnetic flux without saturation. Preferably, the reduced section is located near the attachment point of the cantilever.

In an alternative embodiment, there is provided suspended or cantilevered armature having a resiliently suspended movable contact zone associated with a magnetic shunt of sufficient cross-section to retain the operating magnetic flux, there being an air-gap at the end of the shunt proximate to the fixed contact point, the contact zone of the armature bridging the shunt air-gap, at least the bridging section including a ferro-magnetic material. The armature would carry a conductive path or be made of conductive material, but need not itself be ferro-magnetic. Preferably, the section of ferro-magnetic material is of sufficient cross-section to reduce or avoid saturation at the operating flux. It is preferable that the thickness is sufficient to eliminate saturation at the operating flux. Nickle has both ferro-magnetic and electrical conductivity characteristics, but other types of materials may be selected separately for their magnetic and electrical characteristics in this embodiment.

Another object of the present invention is to provide an array of relays including a plurality of relays according to the invention, the magnetic circuit of each relay being formed on an upper and a lower surface of a PCB and being connected via a pair of through holes, the operating electrical coils being embedded in the PCB.

The invention will be described with reference to the accompanying drawings.

FIG. 1 shows an exploded view of a miniaturized relay of EP02290608.5.

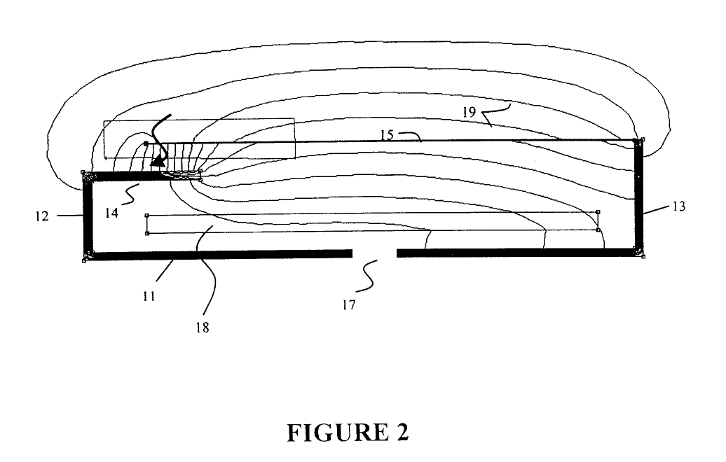

FIG. 2 illustrates the arrangement of the magnetic circuit of EP02290608.5.

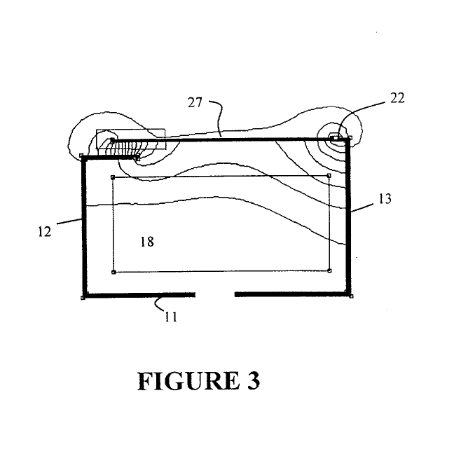

FIG. 3 shows a first embodiment of the invention.

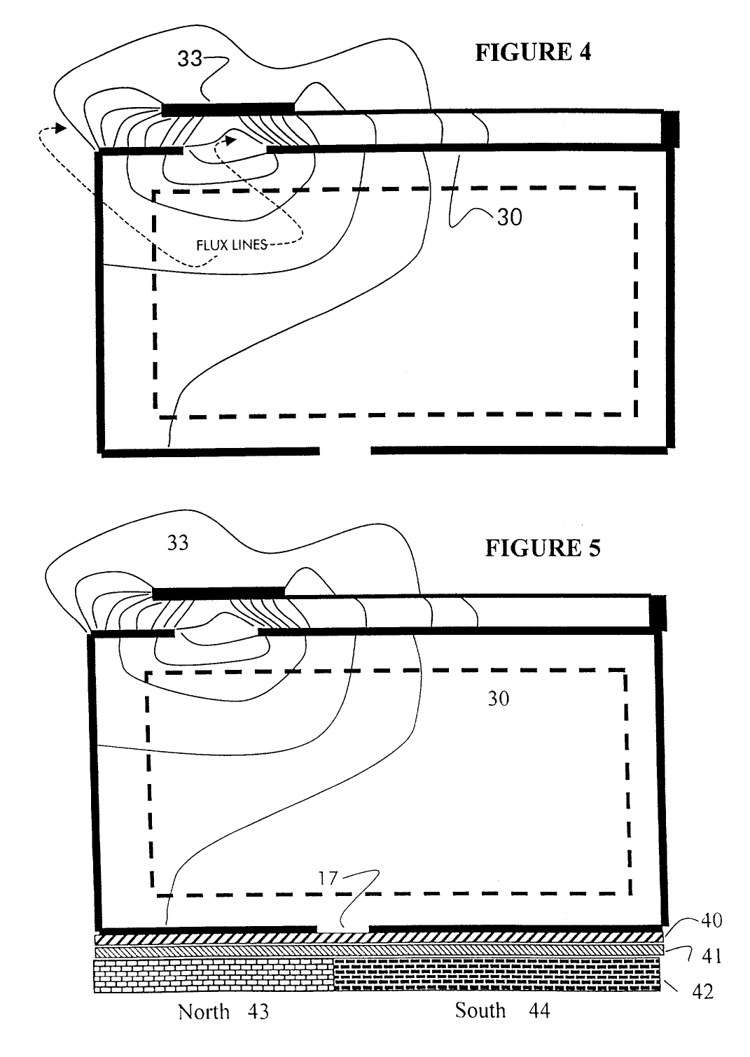

FIG. 4 shows a second embodiment of the invention.

FIG. 5 shows a further embodiment of the invention.

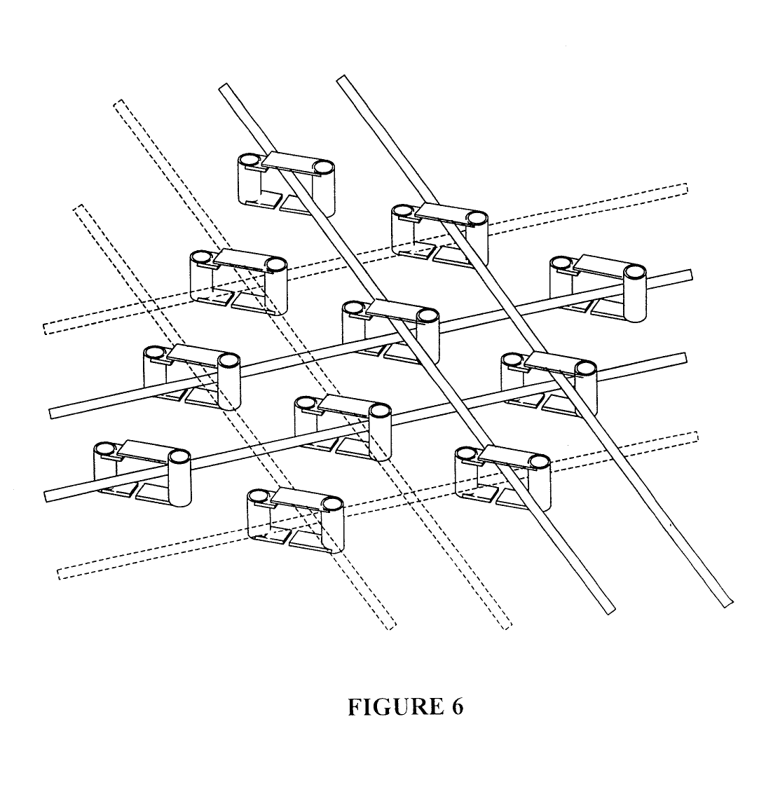

FIG. 6 shows an array of relays according to the invention

FIG. 1 has already been described in reference to EP02290608.5.

In FIG. 2, the substrate has been omitted for clarity. The magnetic circuit includes a bottom portion 11 formed on the bottom surface of the substrate, two through-hole portions, 12 & 13 formed to connect the top and bottom surfaces of the substrate, a contact portion, 14 formed on the top surface of the substrate, and an armature 15 cantilevered above the substrate. There is a contact gap 16 between the end of the armature and the contact 14, and there may be a further air-gap 17, conveniently formed in the bottom section, 11, to provide electrical isolation between the two sides of the electrical contact in the open position. An operating coil 18 passes through the magnetic path loop. The substrate may be for example, a multi-layer PCB to facilitate the inclusion of the operating coils in the substrate. It is also possible to include the bottom section of the magnetic path, 11 within the substrate.

The armature 15 is made thin to reduce the force required to operate the armature. This results in a small cross-section which has a proportionately small saturation flux limit. The flux lines, 19, can be seen exiting the armature 15, indicating that the armature is saturated. As a consequence, the ampere turns to operate the armature is large if the armature saturates.

As part of the background information in designing magnetic circuits, use can be made of the analogy between magnetic and electrical circuits. Magnetic circuits can be analysed in a manner analogous to electrical circuits.

In a magnetic circuit

F=Rφ,

where F is the ampere turns, φ=BA=total flux; A=cross-sectional area; B=flux density; and r is the reluctance of the magnetic circuit. Reluctance may be considered as analogous to resistance in an electric circuit, the flux is equivalent to the current, and the ampere turns equates to the voltage. Thus, to a first approximation, a reluctance network can be analysed in the same manner as a resistance network.

Reluctance is calculated by dividing the length of the magnetic path I by the permeability times the cross-sectional area A; thus the Greek letter mu, μ, symbolizing the permeability of the medium forming the magnetic circuit. The units of reluctance are ampere-turns per weber. These concepts can be employed to calculate the reluctance of a magnetic circuit and thus the current required through a coil to force the desired flux through this circuit.

Our investigations have shown that the armature tends to saturate magnetically before contact, and this greatly increases the current needed to produce the operating magnetic flux to operate the armature. However, when we increased the thickness of the armature, the stiffness also increased, so that, even when the armature was not saturated, large currents were still required to operate the armature to overcome the mechanical strength of the armature.

FIG. 3 shows a first embodiment of the invention, in which the cross-section of the armature 27 is increased by increasing the thickness and/or the width. In this case, the thickness is shown as increased. This produces a proportionate increase in the flux carrying capacity of the armature. The force required to bend the armature to the contact position is increased due to the increase in the cross-section, particularly where the increase is in the same plane as the motion of the armature, ie, when the thickness is increased. Near the attachment point of the armature, 27, the cross-section of the armature is reduced by a notch 22. This reduced cross-section portion functions as a hinge to reduce the force required to bend the armature to contact the contact pad 14. Because the notch is small, much of the flux which escapes from the beam at the notch is recaptured by the beam on the other side of the notch, the flux preferentially following the lower reluctance path rather than the air path. The beam thickness can be increased to avoid saturation at the operating flux.

FIG. 4 shows an alternative embodiment of the invention using a magnetic shunt, 30, to carry the magnetic flux to an air-gap proximate to the contact end of the armature. The shunt 30 may be formed on the top of the substrate at the same time as the contact pad is formed. In this embodiment, the armature may be of similar dimensions to the armature of FIG. 2, but the magnetic force produced is greater and is applied substantially at the end of the cantilever, increasing the turning moment because the flux is carried in the shunt to the shunt/contact air-gap, producing a larger flux density in this air-gap. Attraction forces are produced as the flux enters the end of the armature and as the flux exits the armature. The amount of flux which is “captured” by the end of the armature bridging the shunt/contact air gap depends on the relative reluctance of the path from the shunt to the end section of the armature added to the reluctance of the end of the armature plus the armature/contact air-gap compared with the shunt/contact air-gap 31. Thus the shunt/contact air-gap should provide magnetic reluctance larger than the reluctance of the contact air-gap 16 plus the air-gap between the armature and the shunt 32 to ensure that a significant amount of the flux is diverted through the end of the armature rather than bridging the shunt/contact air-gap.

In a preferred embodiment, the end of the armature is formed of a thickened ferro-magnetic section 33. Preferably the thickness is sufficient to avoid saturation at the operating flux. The increased cross-section produces an increase in the captured flux by reducing the reluctance of the path from the shunt to the contact via the armature end. The increase in the captured flux in turn increases the force applied to the beam. Thus the rest of the armature can be left with a thinner section to retain flexibility.

The armature attachment point of this embodiment can now be electrically and magnetically decoupled from the magnetic path.

Because the flux now enters the thickened section of the armature when it leaves the shunt, and leaves the thickened section near the contact pad, there is an increase in the force of attraction pulling the armature towards the PCB.

FIG. 5 shows a further embodiment of the invention including a magnetic sheet, 42, having alternate magnetic poles in strips corresponding to the layout of the relay array. Only the N-S pair under one relay is shown in the figure. Permanent magnets are high reluctance elements, so to improve the latching of the relay, we have added a sheet of magnetizable material, 41, between the magnetic circuit of the relay and the magnetic sheet 42. To ensure electrical isolation between the electrical contacts, an insulating sheet 40, can be included between the magnetizable sheet, 41, and the magnetic circuit of the relay. The magnetizable sheet 41 acts as a low reluctance path across the air gap 17.

As shown in FIG. 5, the North pole strip, 43, and the South pole strip, 44, are aligned to meet in the region f the air-gap 17.

FIG. 6 shows an array of relays including a plurality of relays according to the invention.

1. A relay having a magnetically cantilevered armature, said contact armature having a section with reduced cross section over a part of its length to provide a hinge action.

2. A relay according to claim 1 wherein said cantilevered armature is at least in part made of a ferro-magnetic material which has a sufficient cross section to retain a large portion of the operating magnetic flux without saturation.

3. A relay according to any one of claims 1 or 2, wherein said section with reduced cross section is located proximate the attachment point of said cantilevered armature.

4. A relay according to claim 1 having a magnetic path including a magnetic shunt of sufficient cross-section to retain the operating magnetic flux, there being a shunt/contact air-gap at the end of said shunt proximate to the contact point, and a section of a resilient armature bridging the shunt air-gap, at least the bridging section including a ferro-magnetic material.

5. A relay according to claim 4 wherein said armature includes a conductive path.

6. A relay according to any one of claims 4 or 5 wherein said armature includes conductive material.

7. A relay according to any one of claims 4 to 6 wherein said armature includes ferro-magnetic material.

8. A relay according to any one of claims 4 to 7 wherein the section of ferro-magnetic material is of sufficient cross-section to reduce or avoid saturation at the operating flux.

9. A relay according to any one of claims 1 to 8 wherein said armature includes a conductive path.

10. A relay according to any one of claims 1 to 9 including an air-gap in the magnetic circuit and a permanent magnet bridging the air-gap.

11. A relay according to claim 10, including a ferro-magnetic shunt providing a low reluctance path across said air-gap.

12. An array of relays including a plurality of relays according to any one of the preceding claims, the magnetic circuit of each relay being formed on an upper and a lower surface of a PCB and being connected via a pair of through holes, the operating electrical coils being embedded in the PCB.
